(19) United States
(12) Patent Application Publication
(10) Pub. No.: US 2011/0005464 A1
(43) Pub. Date: Jan. 13, 2011

(54) EQUIPMENT FOR MIGRATORY FISH BREEDING

(76) Inventor: Ichiro Washiyama, Okinawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/921,530

(22) PCT Filed: Mar. 21, 2008
(86) PCT No.: PCT/JP2008/055262

§ 371 Date: Sep. 8, 2010

(51) Int. Cl. A01K 63/00; A01K 63/04

(52) U.S. Cl. 119/224

(57) ABSTRACT

Problems to be solved by the present invention are: (i) to make it possible for bred fishes, such as tuna, to swim fully and safely without danger of collision to the wall; (ii) to make it possible for fry to safely survive without being eaten by young and grown fishes; (iii) to largely reduce energy consumption needed for water purification; and (iv) to largely reduce labor needed for cleaning and regenerating filter means. These problems are solved by the invention of equipment for migratory fish breeding, in which a breeding tank formed in a circle and a purified water tank formed in a shape lacking a part of a circle (an “occulted circle”) are included, both tanks closely set together like a pair of eye-glasses. The breeding tank is provided with water lanes for separating infant (fry), young, and grown fishes from each other, each given a circular water current. In the purified water tank, there is placed water filtering means and purified (filtered) water is stored there. Both tanks are held substantially at the same water level, as the tanks are mutually connected by a water duct to supply raw water to the filtering means from the breeding tank, and water injection means for injecting water into the breeding tank from the purified water tank.

### FIELD OF INVENTION

The present invention relates to on shore tanks for migratory fish breeding.

### BACKGROUND OF INVENTION

The inventor-applicant of the present application owns the Japan Patent No. 3837709 (registered Aug. 11, 2006) on an invention of on shore tanks for migratory fish breeding. Various idea and knowledge obtained through execution of the patented invention have enabled the applicant to present here a new patent application on the improvements.

Generally, water in the breeding tank, including the above patented one, needs to be pumped to clarifying tank (or inversely) to remove residual foods or faeces floating in the water, which require a large electric power consumption and piping. Further, there is a problem of laborious cleaning and regenerating operations for maintaining filter means. Today, the energy costs for transferring water is becoming one of serious managerial factors.

Patent document 1 listed below gives one of solutions against the problems raised above, in which a clarifying tank provided with a filter layer and a breeding tank are concentrically arranged together with an airlift system, to save electric power for transferring water and to eliminate piping between tanks. However, the invention in the document differs from the applicant's in that the former deals with non-migratory, still water fishes such as flatfishes, stone fishes or takifugus, in which the lane arrangement with a circular water flow in the breeding tank, that is useful in case of migratory fish breeding, is not employed.

Patent document 1: JP-A-2002-223665

### PROBLEMS TO BE SOLVED BY INVENTION

Problems to be solved by the present invention are those two taken over from the above-mentioned patented invention: (i) to make it possible for bred fishes, such as tuna, to swim fully and safely without danger of collision to the wall; (ii) to make it possible for fry to safely survive without being eaten by young and grown fishes; and new two problems to be solved at the same time: (iii) to largely reduce energy consumption needed for water purification; and (iv) to largely reduce labor needed for cleaning and regenerating filter means.

### MEASURES FOR SOLVING PROBLEMS

The above problems can be solved by the invention of equipment for migratory fish breeding, in which a breeding tank formed in a circle and a purified water tank formed in a shape lacking a part of a circle (“occulted circle” in this specification) are included, both tanks closely arranged like a pair of eye-glasses. The breeding tank is provided with water lanes for separating infant (fry), young, and grown fishes from each other, each given a circular water current. In the purified water tank, there is placed water filtering means and purified (filtered) water is stored there. Both tanks are held substantially at the same water level, as the tanks are mutually connected by a water duct to supply raw water to the filtering means from the breeding tank utilizing a dynamic pressure of the circular water current, and water injection means for injecting water into the breeding tank from the purified water tank.

### ADVANTAGEOUS EFFECTS OF INVENTION

The above problems (i) and (ii) are simultaneously solved by the equipment of the present invention, in which the breeding tank is provided with water lanes formed with net-sheets for separating fishes into generation, and in each lane, a circular water current flows at a given speed in the same direction. The net-sheet is a net which is partly covered with a sheet to enhance durability for protecting fishes.

Collision accidents can be avoided by letting fishes to swim against a high speed water current, by making use of the fish's liking for doing so, as a relative speed against environment is lowered. At the same time, it is possible to give the fishes necessary exercise to lessen their frustration by allowing them to swim at the highest speed. Further, as separate lanes work for dedicated tanks for each generation of fishes, it is possible to consign fishes according to the state of growth without danger of inter-generation eating.

The problem (iii) can be solved by the equipment of the present invention, in which the breeding tank shaped in a circle so that fishes can swim along the circular water flow, and the purified water tank shaped in an eclipse circle are closely arranged like a pair of eye-glasses. Due to this arrangement, the distance over which water is to be transferred within the equipment is reduced to almost the thickness of the tank wall, making the piping between tanks substantially unnecessary. In addition, as the water level difference between tanks is substantially zero, the energy needed to transfer the water between tanks is minimized, and a large energy saving is attained. The above-mentioned tank arrangement makes it possible to provide the lanes in the breeding tank, and to keep a circumference ratio of purified water tank/breeding tank less than unity (approximately ¾ in case of the same tank diameters). On the other hand, if the purified water tank is placed inside the breeding tank, it will be difficult to provide the lanes there. Further, if the purified water tank is placed outside the breeding tank surrounding it, the above-mentioned ratio will be larger than unity, resulting in an increased construction cost.

The problem (iv) can be solved by the water filtering means employed in the present invention, which require almost no labor for cleaning and regeneration operations.

### DESCRIPTION OF PREFERRED EMBODIMENTS

### 1st Embodiment

A water duct is placed at the bottom of the breeding tank, with side windows on one side, against which the circular water flow hits and a portion thereof flows in. This embodiment corresponds to claim 2.

As the water duct lies across the circular water flow on the bottom of the breeding tank, the flow hits on one side of the rectangular duct, on which the side windows are made. Water is introduced into the side windows by the dynamic pressure of the flow. It will be appropriate to cover the windows located in the fry lane with nets, lest the fry are not sucked down.

### 2nd Embodiment

Water injection means consists of a water pipe having an open end thereof on the border wall between tanks, and directing to the outer edge of the circular water flow, and a underwater screw provided in the water pipe. This embodiment corresponds to claim 3.

The water injection means is provided with the underwater screw, the only active component in the equipment, which produces all of the water flows: that are circular water flow in the breeding tank; water supply to the filtering means; and water flow to the injection means. This role can be fully attained with a few, small-powered underwater screws, thanks to the result of above-mentioned energy saving. The quantity of injected water is determined to meet a larger one of necessary water flow for maintaining the circular flow and for purifying water.

### 3rd Embodiment

Filtering means consist of a hollow drum covered with a filtering membrane and an air wheel coupled thereto, and supported horizontally by hollow shafts at both ends. This embodiment corresponds to claim 4.

The hollow drum is almost entirely dipped in the water except for its top, and rotated together with the air wheel driven by air from an air source. Raw water is supplied through the hollow shafts. The drum can be rotated with small quantity of air as its rotation speed is moderate. Because the drum is provided with a sufficiently large membrane area, and water is filtered while flowing gently from inside to outside of the drum, the dynamic pressure of the circular water current exerted on the water duct is sufficient to give the pressure difference between membrane necessary for filtration, and therefore, the both tanks can be at substantially the same water levels.

### 4th Embodiment

The filtering means is provided with plural water spray nozzles above the hollow drum, and the membrane is continuously reverse-washed by the nozzles. This embodiment corresponds to claim 5.

As the filtered substance is held lightly on inside of the membrane, it can be easily reverse-washed with small quantity of washing water. Reverse-washing is carried out automatically and continuously throughout the operation, labor needed for cleaning and regeneration of the filtering means is substantially zero.

### EXAMPLES

### 1st Example

An example with respect to the invention of claim 1 will be explained in the following with reference to the attached drawings. FIG. 1(A) is a conceptual plan view showing the equipment for migratory fish breeding, and FIG. 1(B) is a conceptual sectional view of the equipment in the A-A′ arrows direction (hereinafter “view of A-A′ arrows) shown in FIG. 1(A). Purified water zone, raw water zone and oyster-shell zone are shown by respective patterns in FIG. 1 (A).

FIG. 2(A) is a view of B-B′ arrows in FIG. 1(B) in which the water duct, filtering means and water jet hole on the tank border wall are shown. FIG. 2(B) is a view of C-C′ arrows in FIG. 1(A) in which the water injection means consisting of the under water screw, water pipe and the water jet hole are shown, and FIG. 2(C) is a view of D-D′ arrows in FIG. 1(A) in which the buffer plates with oyster-shell layer in the purified water tank are shown.

The breeding tank 1 is a circular water tank of approximately 30 meters in diameter and 11 meters high, and the purified water tank 3 is one shaped in the occulted circle, to which the breeding tank 1 is put together as closely as a pair of eye-glasses, having the border wall 2 in-between.

The inside of the breeding tank 1 is divided into water lanes 11, 12, and 13 for grown fish, young fish and infant fish (fry), respectively, to separate them from each other, by net-sheets 16 which only water can pass through. In the lanes, circular water currents 14 are let flow in the same direction. Nets in the net-sheet are meshed having a size which fishes can not pass through and placed separately in upper and lower positions of the net-sheet where fish density is low. A sheets is placed in the middle position of the net-sheet, and provided with strength and elasticity that can not be broken when the fishes rush at it at their highest speed.

The water duct 15 is laid on the bottom of the breeding tank 1 along its radius connecting the centers of the both tanks, and introduces raw water of the breeding tank 1 to the water filtering means 5. The water duct is a rectangular trough placed on the bottom plate of the breeding tank 1 laid upside down and provided with side windows against which the circular water current strikes. It can be easily removed and cleaned.

There is a tower built inside the purified water tank 3, consisting of a raw water pool 31, a filter pool 32 and a purified water pool 33. The water filtering means 5 is placed in the filter pool 32, with its almost entire body immersed in the water. The raw water flows in the water duct 15, passes through the tank border wall 2, and ascends in the raw water pool 31 to the water filtering means.

Purified water after filtration flows out from the filter pool 32 to the purified water pool 33 and further to the purified water tank 3, where the purified water is held at the same water level as that of the breeding tank 1. A portion of the purified water is constantly discharged to the outside and fresh water of the same quantity is added to avoid accumulation of bacteria. The purified water flows slowly in a wide water channel of the purified water tank 3, and makes its way in the oyster shell layer while being changed its flow directions up and down by the buffer plates 34 and increasing clearness, to adjacent of the water injection means 4. There, the purified water is spouted from the injection hole 43 and joins the circular water current 14.

Now, the breeding tank is needed to be a circle because in which the circular water current 14 is let flow to make fishes to swim. However, as this does not apply to the purified water tank 3, it can take any form such as a tetragon. Though, a circle gives a minimum circumference for a given surrounded area. If the purified water tank 3 is built in a form including a circle even if partly, flows within the tank become smooth resulting in savings in energy consumption and construction material. Further, if the diameters of the both tanks are the same, there arises merits in that concrete frames for construction of tanks can be utilized in common, and a good aerial appearance of the tanks is given.

As the result of unification of the both tanks into a single equipment, a sharp decrease in energy consumption required for transferring water between the tanks has been realized. Required power for transferring water of 6,000 liters per minute is:
750 W×3 units=2,250 W in conventional pump system, and
90 W×2 units=180 W in the present example.
   Namely, the required power for transferring water of the same quantity has decreased to 1/10. This is the result of decrease in transferring distance and water head difference.

### 2nd Example

This example relates to the inventions of claims 4 and 5.

FIG. 3(A) shows a partially broken plan view of a hollow drum and air wheel included in a rotating drum type water filter which constitutes the filtering means 5. FIG. 3 (B) explains the air wheel and an air source.

The filtering means 5 is the rotating drum type water filter, which consists of the hollow drum 51 over which a filtering membrane 52 is stretched, and the air wheel 54 connected with the hollow drum 51, supported horizontally by rotational axes 53 at both ends.

The hollow drum 51 is immersed in the purified water up to near the top and rotated by the air wheel 54 driven by air supplied from the attached air source 6. The raw water is supplied through the rotational axes 53 and filtered while flowing from inside to outside of the hollow drum 51.

Above the hollow drum 51, there is installed water shower nozzles 7, with which the filtering membrane 52 on the hollow drum 51 is continuously reverse-washed. Exhaust water from reverse-washing is drained to the outside through a drain pallet and drain pipe 8.

### BRIEF DESCRIPTION OF DRAWING

FIG. 1(A): A conceptual plan view showing the equipment for migratory fish breeding.

FIG. 1(B): A conceptual sectional view of the equipment in the A-A′ arrows direction shown in FIG. 1(A).

FIG. 2 (A): A view of B-B′ arrows in FIG. 1(B) in which the water duct, filtering means and water jet hole on the tank border wall are shown.

FIG. 2 (B): A view of C-C′ arrows in FIG. 1(A) in which the water injection means consisting of the under water screw, water pipe and the water jet hole are shown.

FIG. 2 (C): A view of D-D′ arrows in FIG. 1(A) in which the buffer plates with oyster-shell layer in the purified water tank are shown.

FIG. 3 (A): A view showing a partially broken plan view of a hollow drum and air wheel included in a rotating drum type water filter which constitutes the filtering means 5.

FIG. 3(B): Explains the air wheel and an air source.

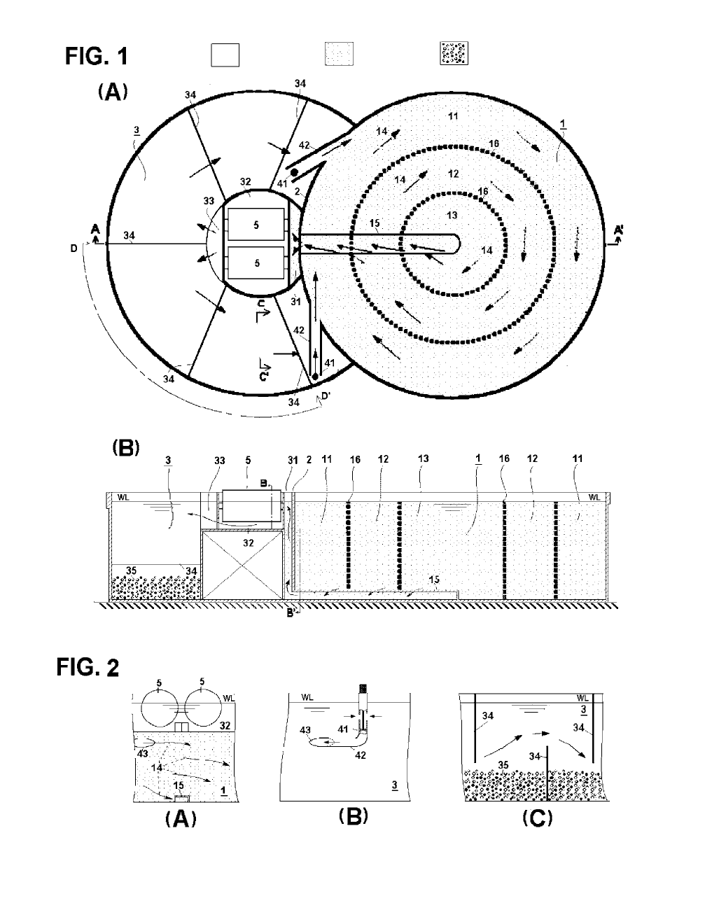

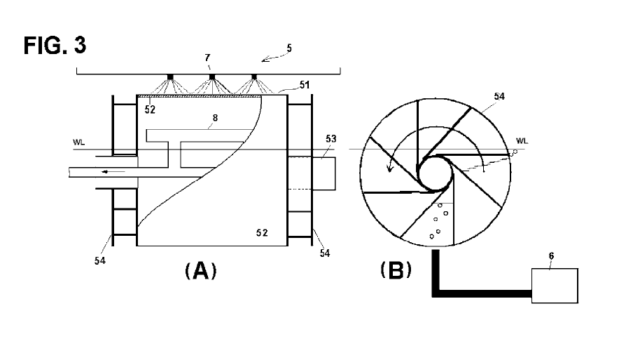

### REFERENCE SIGNS

1 breeding tank, 2 border wall, 3 purified water tank, 4 water injection means, 5 water filtering means, 6 air source, 7 water shower nozzle, 8 drain pallet and drain pipe, 11 water lane for grown fish, 12 water lane for young fish, 13 water lane for infant fish (fry), 14 circular water current, 15 water duct, 16 net-sheet, 51 hollow drum, 52 filtering membrane, 53 rotational axes

1. Equipment for migratory fish breeding, comprising a breeding tank formed in a circle, and a purified water tank formed in a shape lacking a part of a circle (an “occulted circle”), both tanks being closely put together like a pair of eye-glasses, wherein inside of the breeding tank is separated into water lanes for infant (fry), young, and grown fishes, respectively, for separating them from each other, each lane given a circular water current flowing in the same direction;
wherein water filtering means is placed in the purified water tank and purified (filtered) water is stored there; and
wherein both tanks are held at substantially the same water level, as the both tanks are mutually connected by a water duct to supply raw water to the filtering means from the breeding tank utilizing a dynamic pressure of the circular water current, and water injection means for injecting water into the breeding tank from the purified water tank.

2. Equipment according to claim 1, wherein the water duct is laid along the radius of the bottom of the breeding tank, provided with side windows at which the circular water current strikes and a portion thereof flows in.

3. Equipment according to claim 2, wherein the water injection means consists of water pipes directed to the outermost tangential line of the circular water current, whose injection holes open on an tank border wall, and a underwater screw installed in each water pipe.

4. Equipment according to claim 3, wherein the water filtering means is a rotating drum type water filter, which consists of a hollow drum over which a filtering membrane is stretched, and an air wheel connected with the hollow drum, supported horizontally by rotational axes at both ends.

5. Equipment according to claim 4, wherein the water filtering means is provided with water shower nozzles above the hollow drum, the filtering membrane being automatically and continuously reverse-washed by the water shower nozzles.
